(19) United States
(12) Patent Application Publication
(10) Pub. No.: US 2022/0400399 A1
(43) Pub. Date: Dec. 15, 2022

(54) SYSTEM AND METHOD TO MONITOR A RADIO CHANNEL WHILE SERVICING OTHER RADIO CHANNELS

(71) Applicant: ARRIS Enterprises LLC, Suwanee, GA (US)

(72) Inventors: James R. FLESCH, Doraville, GA (US); Ian G. WHEELOCK, Cork (IE); Charles Peter CHEEVERS, Alpharetta, GA (US)

(21) Appl. No.: 17/749,483

(22) Filed: May 20, 2022

Related U.S. Application Data
(60) Provisional application No. 63/209,604, filed on Jun. 11, 2021.

(51) Int. Cl. H04W 24/10; H04B 17/309; H04L 1/00

(52) U.S. Cl. CPC H04W 24/10; H04B 17/309; H04L 1/0026; H04W 88/06

(57) ABSTRACT

A network device having a memory, a radio system, a control line, and a processor. The radio system can operate in a first channel state or a second channel state. The first channel state enables transmission of first client device reception data on a first channel, reception of first client device transmission data on the first channel, and reception of second client device transmission data on a second channel. The second channel state enables transmission of second client device reception data on the second channel, reception of second client device transmission data on the second channel, and reception of first client device transmission data on the first channel. The processor determines a portion of time for which the radio system should be configured to operate in the first channel state.

### BACKGROUND

Embodiments of the disclosure relate to operating a network device on several frequency bands.

### SUMMARY

Aspects of the present disclosure are drawn to a network device for use with a first client device and a second client device. The first client device is configured to transmit first client device transmission data on a first channel and to receive first client device reception data on the first channel. The second client device is configured to transmit second client device transmission data on a second channel and to receive second client device reception data on the second channel. The first channel is different from the second channel. The network device comprises a memory, a radio system, a control line, and a processor. The radio system can be controllably configured to operate in a first channel state or a second channel state. The first channel state enables transmission of the first client device reception data on the first channel, reception of the first client device transmission data on the first channel, and reception of the second client device transmission data on the second channel. The second channel state enables transmission of the second client device reception data on the second channel, reception of the second client device transmission data on the second channel, and reception of the first client device transmission data on the first channel. The control line is arranged to provide a control signal to the radio system so as to place the radio system in either the first channel state or the second channel state. The processor is configured to execute instructions stored on the memory to cause the network device to determine a portion of time for which the radio system should be configured to operate in the first channel state, generate the control signal to place the radio system in the first channel state based on the determined portion of time, and transmit the control signal to the radio system via the control line to place the radio system in the first channel state upon generation of the control signal.

In some embodiments, the radio system comprises a medium access control (MAC) device, a physical layer (PHY) device, a radio frequency (RF) module, a filter bank, a power amplifier, and a low noise amplifier. The MAC device is configured to manage a link layer and frames associated with the first client device transmission data, the first client device reception data, the second client device transmission data, and the second client device reception data. The PHY device is configured to modulate the frames associated with the first client device transmission data and the second client device transmission data and to demodulate the frames associated with the first client device reception data and the second client device reception data. The RF module is configured to associate the first client device transmission data to the first channel, disassociate the first client device reception data from the first channel, associate the second client device transmission data to the second channel, and disassociate the second client device reception data from the second channel. The filter bank is controllably configured to operate in the first channel state or the second channel state. The power amplifier is configured to amplify the first client device transmission data and the second client device transmission data. The low noise amplifier is operable to filter the first client device reception data and the second client device reception data. The control line is arranged to provide the control signal to the filter bank so as to place the filter bank in either the first channel state or the second channel state.

In some embodiments, the radio system is configured to operate in a first GHz band in the first state and to operate in a second GHz band in the second state.

In some embodiments, the network device further comprises a second radio system configured to operate in a third GHz band while operating in the first state or the second state.

Other aspects of the present disclosure are drawn to a method of using a network device with a first client device and a second client device. The first client device is configured to transmit first client device transmission data on a first channel and to receive first client device reception data on the first channel. The second client device is configured to transmit second client device transmission data on a second channel and to receive second client device reception data on the second channel. The first channel is different from the second channel. The method comprises determining, via a processor configured to execute instructions stored on a memory, a portion of time for which a radio system should be configured to operate in a first channel state based on the monitored first client device parameter and the monitored second client device parameter. The radio system is controllably configured to operate in a first channel state or a second channel state. The first channel state enables transmission of the first client device reception data on the first channel, reception of the first client device transmission data on the first channel, and reception of the second client device transmission data on the second channel. The second channel state enables transmission of the second client device reception data on the second channel, reception of the second client device transmission data on the second channel, and reception of the first client device transmission data on the first channel. The method also comprises generating, via the processor, the control signal to place the radio system in the first channel state based on the determined portion of time and transmitting, via the processor, the control signal to the radio system via a control line to place the radio system in the first channel state upon generation of the control signal.

In some embodiments, the radio system comprises a medium access control (MAC) device, a physical layer (PHY) device, a radio frequency (RF) module, a filter bank, a power amplifier, and a low noise amplifier. The MAC device is configured to manage a link layer and frames associated with the first client device transmission data, the first client device reception data, the second client device transmission data, and the second client device reception data. The PHY device is configured to modulate the frames associated with the first client device transmission data and the second client device transmission data and to demodulate the frames associated with the first client device reception data and the second client device reception data. The RF module is configured to associate the first client device transmission data to the first channel, disassociate the first client device reception data from the first channel, associate the second client device transmission data to the second channel, and disassociate the second client device reception data from the second channel. The filter bank is controllably configured to operate in the first channel state or the second channel state. The power amplifier is configured to amplify the first client device transmission data and the second client device transmission data. The low noise amplifier is operable to filter the first client device reception data and the second client device reception data. Transmitting the control signal comprises transmitting the control signal to the filter bank so as to place the filter bank in either the first channel state or the second channel state.

In some embodiments, the method further comprises operating the radio system in a first GHz band in the first state and in a second GHz band in the second state.

In some embodiments, the method further comprises operating a second radio system in a third GHz band while operating in the first state or the second state.

Other aspects of the present disclosure are drawn to a non-transitory, computer-readable media having computer-readable instructions stored thereon, the computer-readable instructions being capable of being read by a network device for use with a first client device and a second client device. The first client device is configured to transmit first client device transmission data on a first channel and to receive first client device reception data on the first channel. The second client device is configured to transmit second client device transmission data on a second channel and to receive second client device reception data on the second channel. The first channel is different from the second channel. The computer-readable instructions are capable of instructing the network device to perform the method comprising determining, via a processor configured to execute instructions stored on a memory, a portion of time for which a radio system should be configured to operate in a first channel state based on the monitored first client device parameter and the monitored second client device parameter. The radio system is controllably configured to operate in a first channel state or a second channel state. The first channel state enables transmission of the first client device reception data on the first channel, reception of the first client device transmission data on the first channel, and reception of the second client device transmission data on the second channel. The second channel state enables transmission of the second client device reception data on the second channel, reception of the second client device transmission data on the second channel, and reception of the first client device transmission data on the first channel. The method also comprises generating, via the processor, the control signal to place the radio system in the first channel state based on the determined portion of time and transmitting, via the processor, the control signal to the radio system via a control line to place the radio system in the first channel state upon generation of the control signal.

In some embodiments, the computer-readable instructions are capable of instructing the network device to perform the method wherein the radio system comprises a medium access control (MAC) device, a physical layer (PHY) device, a radio frequency (RF) module, a filter bank, a power amplifier, and a low noise amplifier. The MAC device is configured to manage a link layer and frames associated with the first client device transmission data, the first client device reception data, the second client device transmission data, and the second client device reception data. The PHY device is configured to modulate the frames associated with the first client device transmission data and the second client device transmission data and to demodulate the frames associated with the first client device reception data and the second client device reception data. The RF module is configured to associate the first client device transmission data to the first channel, disassociate the first client device reception data from the first channel, associate the second client device transmission data to the second channel, and disassociate the second client device reception data from the second channel. The filter bank is controllably configured to operate in the first channel state or the second channel state. The power amplifier is configured to amplify the first client device transmission data and the second client device transmission data. The low noise amplifier is operable to filter the first client device reception data and the second client device reception data. Transmitting the control signal comprises transmitting the control signal to the filter bank so as to place the filter bank in either the first channel state or the second channel state.

In some embodiments, the computer-readable instructions are capable of instructing the network device to perform the method wherein the radio system is configured to operate in a first GHz band in the first state and to operate in a second GHz band in the second state.

In some embodiments, the computer-readable instructions are capable of instructing the network device to perform the method further comprising operating a second radio system in a third GHz band while operating in the first state or the second state.

### BRIEF SUMMARY OF THE DRAWINGS

The accompanying drawings, which are incorporated in and form a part of the specification, illustrate example embodiments and, together with the description, serve to explain the principles of the present disclosure. In the drawings:

FIG. 1 illustrates a system of client devices connected to a network device;

FIG. 2 illustrates a prior-art network device connected to client devices;

FIG. 3 illustrates a network device connected to client devices, in accordance with aspects of the present disclosure;

FIGS. 4A-B illustrate the network device in first and second states, in accordance with aspects of the present disclosure;

FIG. 5 illustrates a method of operating the network device in first and second states, in accordance with aspects of the present disclosure;

FIGS. 6A-B illustrate the network device operating in first and second states, in accordance with aspects of the present disclosure; and

FIGS. 7A-B illustrate a radio system operating in first and second states, in accordance with aspects of the present disclosure.

### DETAILED DESCRIPTION

Internet-enabled devices such as computers, smart phones, tablets, smart speakers, home security devices, and others are ubiquitous in modern homes and workplaces. These client devices are often networked together and connected to the Internet using wireless network devices. In many cases, network devices utilize Wi-Fi wireless network standards. Wi-Fi standards have evolved over time to operate with various protocols, modulation schemes, and radio frequency bands. As Wi-Fi standards change, client devices and network devices adopt these new standards in order to provide better performance and reliability. These changes often require new hardware or software and often result in additional costs.

The majority of today's client devices operate on Wi-Fi over the 2.4 and 5 GHz bands. Client devices using the 6 GHz Wi-Fi band are just beginning to appear on the market. In response, newly developed network devices can flexibly configure their radio systems to operate on the 2.4, 5, or 6 GHz bands as needed. However, a network device cannot solely operate on one band; it must also monitor other bands for any client devices requesting service.

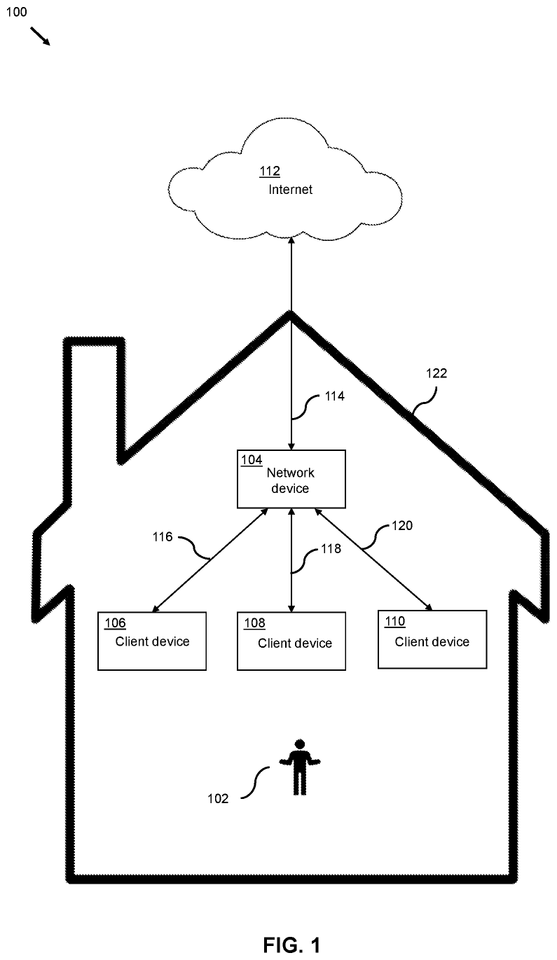

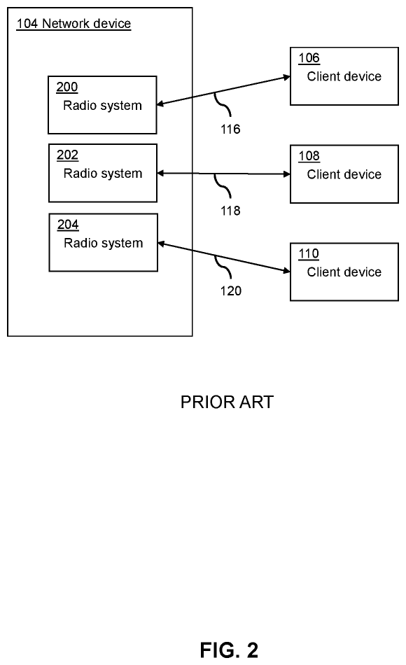

A prior-art system and method for supporting 2.4, 5, and 6 GHz bands in a network device will now be described in greater detail with reference to FIG. 1-2.

FIG. 1 illustrates a prior-art system 100 of client devices connected to a network device.

As shown in the figure, system 100 includes a user 102, a network device 104, client devices 106, 108, and 110, and Internet 112. User 102, network device 104, and client devices 106, 108, and 110 are disposed at location 122. Network device 104 is arranged to communicate with client device 106 by a channel 116. Network device 104 is arranged to communicate with client device 108 by a channel 118. Network device 104 is arranged to communicate with client device 110 by a channel 120. Network device 104 is arranged to communicate with Internet 112 by a channel 114.

Network device 104 may be any device or system that is operable to allow data to flow from one discrete device or network to another. Network device 104 may perform such functions as web acceleration and HTTP compression, flow control, encryption, redundancy switchovers, traffic restriction policy enforcement, data compression, TCP performance enhancements (e.g., TCP spoofing), quality of service functions (e.g., classification, prioritization, differentiation, random early detection, TCP/UDP flow control), bandwidth usage policing, dynamic load balancing, address translation, and routing. In this non-limiting example, network device 104 may be a router, a gateway, an access point, an extender, or a mesh network device.

Client devices 106, 108, and 110 are any devices or systems that present content to, accept inputs from, or directly or indirectly interact with user 102. In this non-limiting example, client devices 106, 108, and 110 may be smart phones, tablets, personal computers, TV set-top boxes, videogame consoles, smart media devices, home security devices, or Internet-of-Things (IoT) devices.

Internet 112 is a global set of interconnected computing resources and networks.

Channel 114 may be any device or system that facilitates communications between devices or networks. Channel 114 may include physical media or wiring, such as coaxial cable, optical fiber, or digital subscriber line (DSL); or wireless links, such as Wi-Fi, LTE, satellite, or terrestrial radio links; or a combination of any of these examples or their equivalents. The term “Wi-Fi” as used herein may be considered to refer to any of Wi-Fi 4, 5, 6, 6E, or any variation thereof. The data communicated on such networks can be implemented using a variety of protocols on a network such as a WAN, a virtual private network (VPN), a metropolitan area network (MAN), a system area network (SAN), a DOCSIS network, a fiber optics network (including fiber-to-the-home, fiber-to-the-X, or hybrid fiber-coax), a digital subscriber line (DSL), a public switched data network (PSDN), a global Telex network, or a 2G, 3G, 4G or 5G, for example. Though channel 114 is shown as a single link, it is contemplated that channel 114 may contain multiple links and devices, including access points, routers, gateways, and servers.

Channels 116, 118, and 120 are any devices or systems that facilitate wireless communications between network device 104 and client devices 106, 108, and 110 respectively. In this non-limiting example, channels 116, 118, and 120 are Wi-Fi bands.

In normal operation, network device 104 enables data communications between Internet 112, client device 106, client device 108, and client device 110. User 102 may interact with client devices 106, 108, and 110 at various times and interaction levels. For purposes of discussion, suppose that user 102 is watching streaming video on client device 106. User 102 then decides to stop the video and start browsing the Web on client device 108. Also suppose that client device 110 is a security camera that records video to a service based in Internet 112.

In this non-limiting example, client device 106 communicates to network device 104 over channel 116 using a 5 GHz Wi-Fi band. Client device 108 communicates to network device 104 over channel 118 using a 6 GHz Wi-Fi band. Client device 110 communicates to network device 104 over channel 120 using a 2.4 GHz Wi-Fi band. In another non-limiting example, client device 106 communicates over channel 116 using a 5 GHz low Wi-Fi band and client device 108 communicates over channel 118 using a 5 GHz high Wi-Fi band.

FIG. 1 illustrates system 100 comprising network device 104 and client devices 106, 108, and 110. Aspects of network device 104 communicating with client devices 106, 108, and 110 will now be discussed with reference to FIG. 2.

FIG. 2 illustrates prior-art network device 104 connected to client devices 106, 108, and 110.

As shown in the figure, network device 104 includes radio systems 200, 202, and 204. Radio system 200 is arranged to communicate with client device 106 by channel 116. Radio system 202 is arranged to communicate with client device 108 by channel 118. Radio system 204 is arranged to communicate with client device 110 by channel 120.

Referring to the example given in FIG. 1, suppose that channel 116 operates on 5 GHz, channel 118 operates on 6 GHz, and channel 120 operates on 2.4 GHz. In this prior-art example, radio system 200 is utilized specifically to enable channel 116 on 5 GHz, radio system 202 is utilized specifically to enable channel 118 on 6 GHz, and radio system 204 is utilized specifically to enable channel 120 on 2.4 GHz. While user 102 watches video on client device 106, radio system 200 fully services channel 116 and radio system 202 fully services channel 118. When user 102 stops watching video on client device 106 and starts browsing the Web on client device 108, radio system 200 continues to fully service channel 116.

FIG. 2 illustrates prior-art network device 104, which utilizes three radio subsystems to fully service three bands. Prior-art network device 104 will therefore have an increased cost as attributed to the multiple different radio systems that are required to support 2.4 GHz, 5 GHz and 6 GHz bands. Further, for some users, this increased cost may not be justified as their homes may not include client devices that support the 6 GHz band, wherein the radio system providing the 6 GHz band is not being used. Further, in the future, for other users, this increased cost may not be justified as their home may no longer include client devices that support the 5 GHz band, wherein the radio system providing the 5 GHz band will no longer be used. However, it is not sufficient for the radio system to operate on only one band; it must also monitor other bands for any client device requesting service on those bands.

What is needed is a system and method for configuring a radio system to monitor a radio band while fully servicing another band.

A system and method in accordance with the present disclosure enables a network device to monitor a radio band while servicing other radio bands.

In accordance with the present disclosure, a network device is used with several client devices over two wireless communications channels. Each channel comprises a different radio frequency band. The network device can be placed in one state where it is transmitting and receiving data to client devices on a first channel while monitoring client devices on a second channel. In response to the monitored client devices, the network device can switch to another state where it is transmitting and receiving data to client devices on the second channel while monitoring client devices on the first channel.

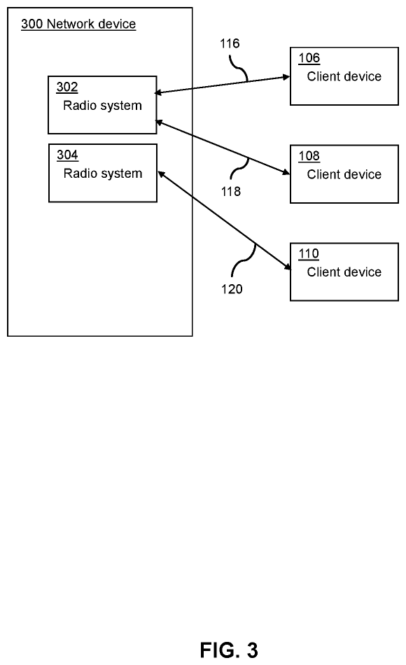

An example system and method of servicing one channel while monitoring another channel in accordance with aspects of the present disclosure will now be described in greater detail with reference to FIGS. 3-7B.

FIG. 3 illustrates a network device 300 connected to client devices 106, 108, and 110, in accordance with aspects of the present disclosure.

As shown in the figure, network device 300 includes radio systems 302 and 304. Radio system 302 is arranged to communicate with client device 106 by channel 116 or with client device 108 by channel 118. This can be done by any method, a non-limiting example of which is disclosed in U.S. patent application Ser. No. 63/038,259, filed on Jun. 12, 2020, the entire disclosure of which is incorporated herein by reference.

Radio system 304 is arranged to communicate with client device 110 by channel 120.

Referring to the example given in FIG. 1, wherein network device 104 is replaced with network device 300. For purposes of discussion only, suppose that channel 116 operates on 5 GHz, channel 118 operates on 6 GHz, and channel 120 operates on 2.4 GHz. In this non-limiting example, radio system 302 is utilized to enable channel 116 on 5 GHz or channel 118 on 6 GHz. Radio system 304 is utilized to enable channel 120 on 2.4 GHz.

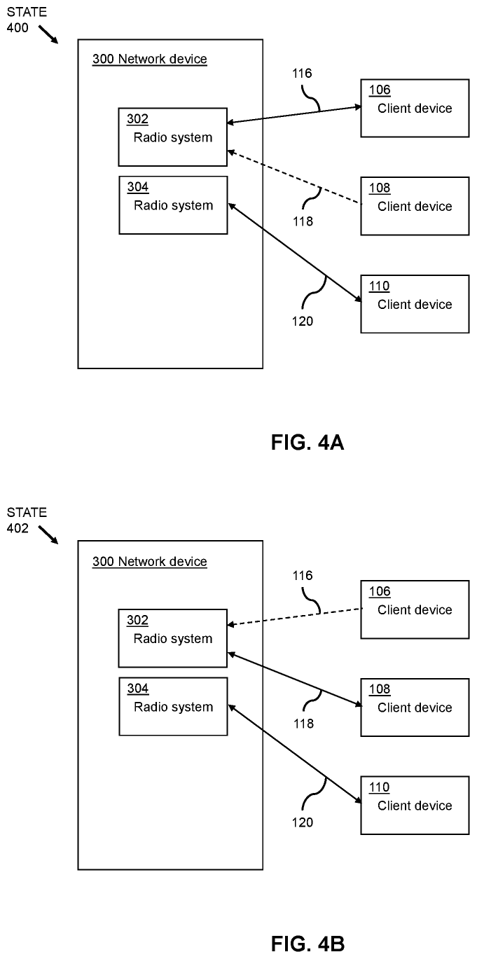

In operation, radio system 302 switches between fully servicing or monitoring channels 116 and 118. The switching of radio system 302 between states will now be discussed with reference to FIGS. 4A-B.

FIGS. 4A-B illustrate network device 300 in states 400 and 402, in accordance with aspects of the present disclosure.

As shown in FIG. 4A, radio system 302 is configured in state 400 to provide full transmission and reception capabilities, as represented by the solid double-ended arrow, to client device 106 on channel 116. In state 400, radio system 302 is configured to monitor, as represented by the dotted arrow, client device 108 on channel 118. In some embodiments, radio system 302 is configured to monitor client device 108 by only receiving information, thus minimizing the required processing resources. In some embodiments, radio system 302 is configured to monitor client device 108 by receiving information, for example a probe request, and only transmitting limited responses, for example an acknowledgment, thus thereby reducing the processing resources.

As shown in FIG. 4B, radio system 302 is configured in state 402 to provide full transmission and reception capabilities, as represented by the solid double-ended arrow, to client device 108 on channel 118. In state 402, radio system 302 is configured to monitor, as represented by the dotted arrow, client device 106 on channel 116. In some embodiments, radio system 302 is configured to monitor client device 106 by only receiving information, thus minimizing the required processing resources. In some embodiments, radio system 302 is configured to monitor client device 106 by receiving information, for example a probe request, and only transmitting limited responses, for example an acknowledgment, thus thereby reducing the processing resources.

In this non-limiting example, monitoring of client device 106 or 108 includes radio system 302 receiving data from client device 106 or 108, respectively. In another non-limiting example, monitoring of client device 106 or 108 includes radio system 302 receiving data from and transmitting data to client device 106 or 108, respectively, where the data transmission is of low bandwidth, encoding, or modulation.

In operation, when radio system 302 is in state 400 as shown in FIG. 4A, network device 300 communicates with client device 106 on channel 116 at high bandwidth and low latency, utilizing full capabilities of radio system 302. Client device 108 may be inactive or asleep, and thus only needs occasional monitoring by network device 300 on channel 118.

As shown in FIG. 4B, client device 108 may become active and request service from network device 300. Client device 106 may around the same time become inactive. Network device 300 algorithmically determines to allocate its hardware and software resources in order to service client device 108 on channel 118. Radio system 302 switches to state 402 to communicate with client device 108 on channel 118 at high bandwidth and low latency. In state 402, radio system 302 monitors client device 106 on channel 116.

As shown in FIGS. 4A-B, network device 300 includes radio system 304 which communicates with client device 110 on channel 120. In this non-limiting example, radio system 304 operates on channel 120 on 2.4 GHz while radio system 302 is in state 400 or state 402.

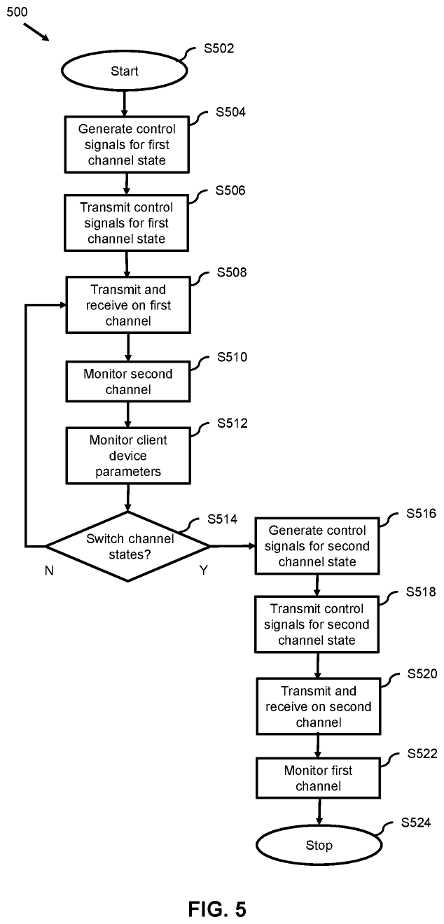

FIGS. 4A-B illustrate network device 300 operating in two states to either fully communicate with or monitor client devices 106 or 108. A method for operating in two states will now be discussed with reference to FIG. 5.

FIG. 5 illustrates an algorithm 500 to be executed by processor 600, in accordance with aspects of the present disclosure.

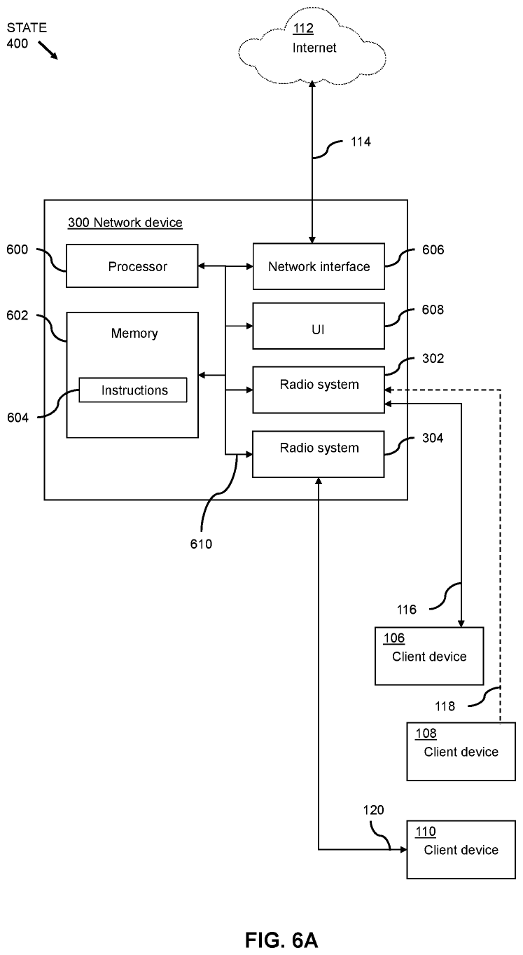

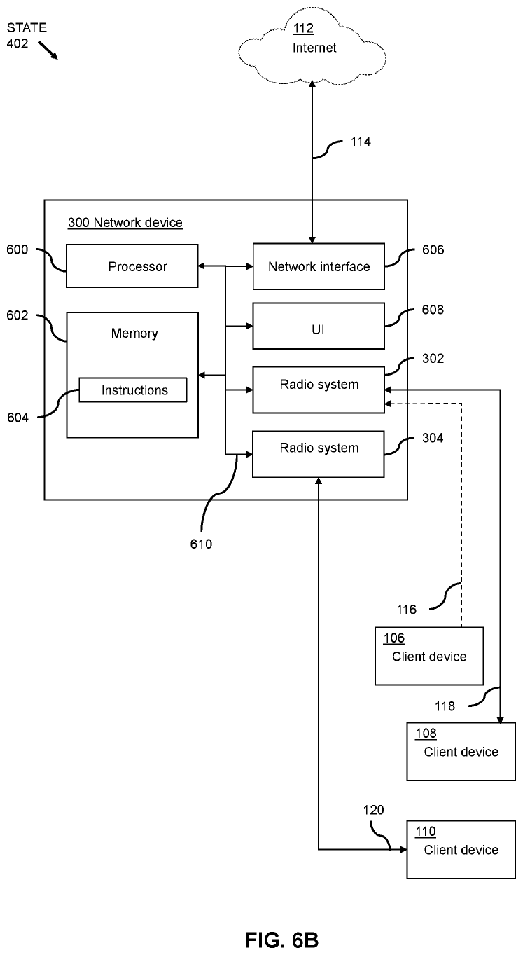

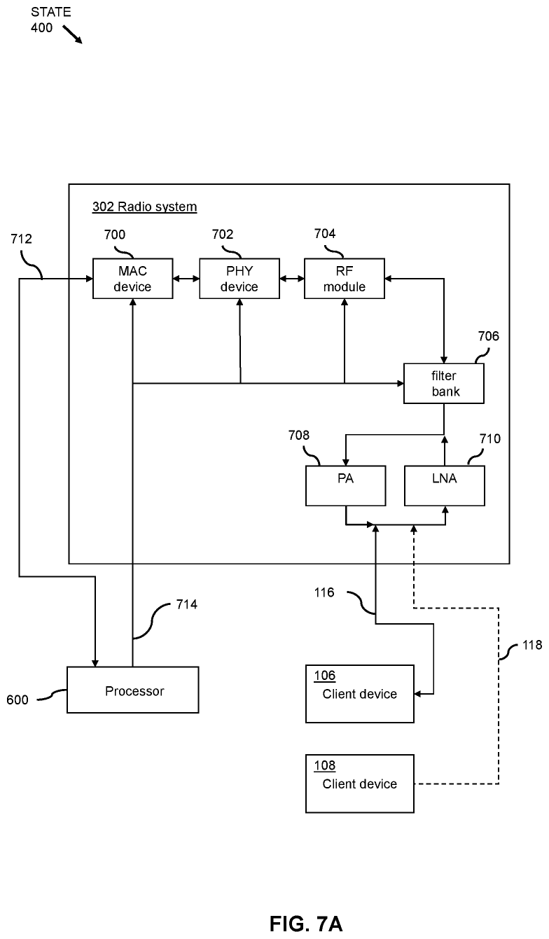

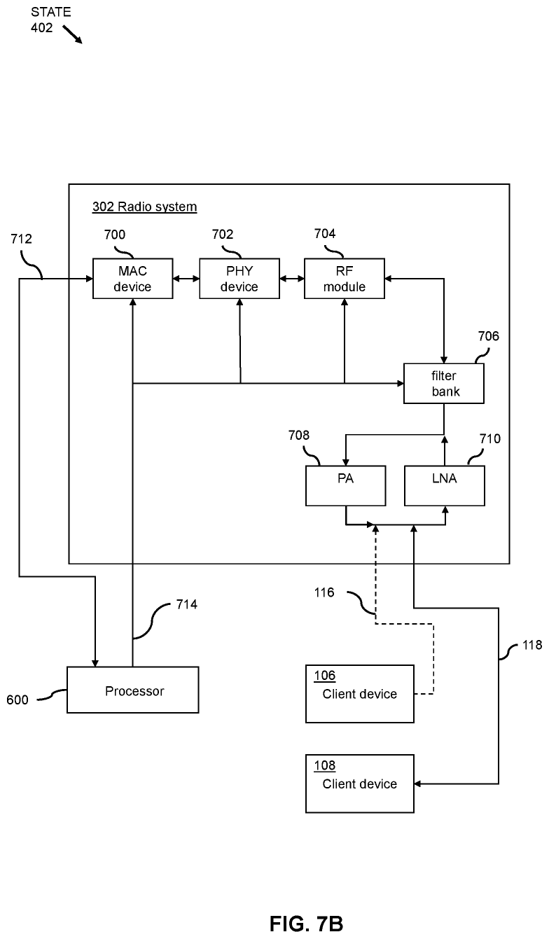

As shown in the figure, algorithm 500 starts (S502) and control signals for the first state are generated (S504). This will now be discussed in greater detail with reference to FIGS. 6A-7B.

FIGS. 6A-B illustrate aspects of network device 300 and client devices 106, 108, and 110, in accordance with aspects of the present disclosure.

As shown in the figures, network device 300 contains a processor 600, a memory 602, a network interface 606, a user interface (UI) 608, a radio system 302, and a radio system 304. Processor 600, memory 602, network interface 606, UI 608, radio system 302, and radio system 304 are connected by a bus 610. Processor 600 is configured to execute instructions 604 stored in memory 602.

Processor 600 may be any device or system capable of controlling general operations of network device 300 and includes, but is not limited to, central processing units (CPUs), hardware microprocessors, single-core processors, multi-core processors, field-programmable gate arrays (FPGAs), microcontrollers, application-specific integrated circuits (ASICs), digital signal processors (DSPs), or other similar processing devices capable of executing any type of instructions, algorithms, or software for controlling the operations and functions of network device 300.

Memory 602 may be any device or system capable of storing data and instructions used by network device 300 and includes, but is not limited to, random-access memory (RAM), dynamic random-access memory (DRAM), hard drives, solid-state drives, read-only memory (ROM), erasable programmable read-only memory (EPROM), electrically erasable programmable read-only memory (EEPROM), flash memory, embedded memory blocks in FPGAs, or any other various layers of memory hierarchy.

Instructions 604 operate the functions of network device 300, including communicating with Internet 112 and client devices 106, 108, and 110. Instructions 604, having a set (at least one) of program modules, may be stored in memory 602 by way of example, and not limitation, as well as an operating system, one or more application programs, other program modules, and program data. Each of the operating systems, one or more application programs, other program modules, and program data or some combination thereof, may include an implementation of a networking environment. The program modules generally carry out the functions and/or methodologies of various embodiments of the application as described herein.

As will be described in greater detail below, instructions 604 include instructions, that when executed by processor 600, cause network device 300 to determine a portion of time for which radio system 302 should be configured to operate in state 400 based on the monitored parameters associated with client device 106 and 108, generate the control signal to place radio system 302 in the state 400 based on the determined portion of time, and transmit the control signal to radio system 302 via a control line to place radio system 302 in state 400 upon generation of the control signal.

Network interface 606 may be any device or system used to establish and maintain channel 114. Network interface 606 can include one or more connectors, such as RF connectors, Ethernet connectors, wireless communications circuitry such as 5G transceivers, and one or more antennas. Network interface 606 transmits and receives data from Internet 112 by known methods, non-limiting examples of which include terrestrial antenna, satellite dish, wired cable, DSL, optical fiber, or 5G as discussed above.

UI 608 may be any device or system capable of presenting information and accepting user inputs on network device 300 and includes, but is not limited to, liquid crystal displays (LCDs), thin film transistor (TFT) displays, light-emitting diodes (LEDs), touch screens, buttons, microphones, and speakers.

In this example, processor 600, memory 602, network interface 606, UI 608, radio system 302, and radio system 304 are illustrated as individual devices of network device 300. However, in some embodiments, at least two of processor 600, memory 602, network interface 606, UI 608, radio system 302, and radio system 304 may be combined as a unitary device. Further, in some embodiments, at least one of processor 600, memory 602, network interface 606, UI 608, radio system 302, and radio system 304 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to processor 600 such that processor 600 may read information from, and write information to, the tangible computer-readable media. In the alternative, the tangible computer-readable media may be integral to processor 600. Processor 600 and the tangible computer-readable media may reside in an integrated circuit (IC), an ASIC, or large scale integrated circuit (LSI), system LSI, super LSI, or ultra LSI components that perform a part or all of the functions described herein. In the alternative, processor 600 and the tangible computer-readable media may reside as discrete components.

Example tangible computer-readable media may be also coupled to systems, non-limiting examples of which include a computer system/server, which is operational with numerous other general-purpose or special-purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Bus 610 may be any device or system that provides data communications between processor 600, memory 602, network interface 606, UI 608, radio system 302, and radio system 304. Bus 610 can be one or more of any of several types of bus structures, including a memory bus or a memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

As shown in FIG. 6A, radio system 302 is configured in state 400 to provide full transmission and reception capabilities to client device 106 on channel 116. In state 400, radio system 302 is configured to monitor client device 108 on channel 118.

As shown in FIG. 6B, radio system 302 is configured in state 402 to provide full transmission and reception capabilities to client device 108 on channel 118. In state 402, radio system 302 is configured to monitor client device 106 on channel 116.

Aspects of radio system 302 switching between states 400 and 402 will now be discussed with reference to FIGS. 7A-B.

FIGS. 7A-B illustrate radio system 302 operating in states 400 or 402, in accordance with aspects of the present disclosure.

As shown in the figure, radio system 302 contains a MAC device 700, a PHY device 702, an RF module 704, a filter bank 706, a power amplifier (PA) 708, and a low noise amplifier (LNA) 710. MAC device 700, PHY device 702, RF module 704, filter bank 706, power amplifier PA 708, and LNA 710 are controlled by processor 600 on a control line 714. Processor 600 sends data to and receives data from radio system 302 on a line 712.

MAC device 700 may be any device or system configured to manage the link layer of a communications protocol stack. In this non-limiting example, MAC device 700 maintains a list of network names, or Service Set IDentifiers (SSIDs), configured on a Wi-Fi band. MAC device 700 also maintains a list of devices, or stations (STAs), configured on each SSID. Control line 714 controls whether MAC device 700 operates in state 400 or in state 402.

PHY device 702 may be any device or system configured to code and modulate digital data onto a communications medium. In this non-limiting example, PHY device 702 transforms digital data into an analog baseband signal when transmitting and transforms an analog baseband signal into digital data when receiving. Control line 714 controls whether PHY device 702 operates in state 400 or in state 402.

RF module 704 may be any device or system that transforms an analog baseband signal to and from wireless communications bands. In this non-limiting example, RF module 704 upconverts a baseband signal provided by PHY device 702 into a radio frequency signal at 5 or 6 GHz when transmitting and downconverts a radio frequency signal from 5 or 6 GHz to baseband when receiving. Control line 714 controls whether RF module 704 operates in state 400 or in state 402.

Filter bank 706 may be any device or system that attenuates certain frequency ranges to improve radio communications performance. In this non-limiting example, control line 714 controls whether filter bank 706 operates in state 400 or in state 402.

PA 708 and LNA 710 may be any devices or systems that amplify radio signals. In this non-limiting example, PA 708 amplifies the power of the Wi-Fi signal being transmitted by radio system 302. LNA 710 amplifies the power of the Wi-Fi signal being received by radio system 302.

Though MAC device 700, PHY device 702, RF module 704, filter bank 706, PA 708, and LNA 710 are illustrated as separate components, it is contemplated that two or more of MAC device 700, PHY device 702, RF module 704, filter bank 706, PA 708, and LNA 710 may be combined into a single device. Furthermore, though filter bank 706 is illustrated as disposed between RF module 704 and PA 708 and LNA 710, it is contemplated that the order of components may differ in other implementations. In another non-limiting example, PA 708 and LNA 710 are disposed between RF module 704 and filter bank 706.

Though line 712 and control line 714 are illustrated as separate components, it is contemplated that one or more of line 712 and control line 714 may be combined together or with bus 610.

Radio system 302 can be switched to operate in state 400 or in state 402. In this non-limiting example, radio system 302 can operate in state 400 on 5 GHz or in state 402 on 6 GHz. In another example, radio system 302 can operate in state 400 on a 5 GHz low band or in state 402 on a 5 GHz high band. In operation, with reference to FIGS. 6A-B, processor 600 executes instructions 604 stored on memory 602 causing control signals to be sent on control line 714 to place radio system 302 into state 400 or state 402.

For example, for purposes of discussion only, consider the situation wherein all the client devices within a residence operate in a 5 GHz low band. In such a situation, processor 600 may place radio system 302 into state 400 to receive data from the client devices and transmit data to the client devices. However, a person may visit the residence, wherein the person has a smart phone that operates in the 6 GHz band. In such as case, this smart phone would not be able to communicate with radio system 302. Therefore, in accordance with aspects of the present disclosure, radio system 302 is able to monitor the 6 GHz band in order to wake up after detecting a 6 GHz band device. Radio system 302 may then switch states in order to operate in the 6 GHz band to service the new smart phone. Radio system 302 may similarly operate in the opposite situation, wherein all the client devices within a residence operate in a 6 GHz low band and then a 5 GHz client device attempts to communicate. In other words, radio system 302 may repeatedly switch between states to service multiple types of client devices that operate in multiple distinct bands.

For purposes of discussion only, in this example let radio system 302 initially operate in state 400. Referring to FIG. 7A, processor 600 generates control signals to configure radio system 302 into state 400.

Returning to FIG. 5, after control signals for the first channel state are generated (S504), control signals are then transmitted (S506). Referring to FIG. 7A, processor 600 transmits control signals on control line 714 to configure MAC device 700, PHY device 702, RF module 704, and filter bank 706 into state 400.

Returning to FIG. 5, after control signals are then transmitted (S506), data is transmitted and received on the first channel (S508). Referring to FIG. 7A, processor 600 of client device 106 transmits data on channel 116 to client device 106 by way of MAC device 700, PHY device 702, RF module 704, filter bank 706, power amplifier 708 and the through an antenna (not shown). Further, processor 600 of client device 106 receives data on channel 116 from client device 106 by way of the antenna (not shown), LNA 710, filter bank 706, RF module 704, PHY device 702, and MAC device 700.

Returning to FIG. 5, after data is transmitted and received on the first channel (S508), the second channel is monitored (S510). In this non-limiting example and referring to FIG. 7A, radio system 302 is configured to only receive data from client device 108 on channel 118. In another example, radio system 302 is configured to receive data from and also transmit low bandwidth, low priority data to client device 108 on channel 118. For example, some communication protocols may require acknowledgements, wherein radio system 302 may transmit the very least required data such as acknowledgments thereby minimizing the processing requirements needed for the communication band that is not currently be totally serviced by radio system 302.

Returning to FIG. 5, after the second channel is monitored (S510), client device parameters are monitored (S512). Referring to FIG. 6A, instructions 604 running on processor 600 monitor parameters of channels 116 and 118 in order to determine when to switch states. Non-limiting examples of such parameters include the number of client devices on channels 116 and 118, Wi-Fi capabilities of client devices 106 and 108, bandwidth requirements of client devices 106 and 108, and combinations thereof.

Returning to FIG. 5, after client device parameters are monitored (S512), a determination whether to switch channels is made (S514). Referring to FIG. 6A, network device 300 monitors whether client device 108 requires full service on channel 118 and also considers factors including Wi-Fi capabilities, application bandwidth needs, and data latency requirements of client devices 106 and 108. The detected values of these monitored parameters may be compared with respective predetermined threshold values stored in 602. If the detected values of these monitored parameters are greater than the respective predetermined threshold values stored in 602, then processor 600 may determine to switch states.

Returning to FIG. 5, if it is determined that channel states do not need to be switched (N on S514), then data continues to be transmitted and received on the first channel (return to S508). For example, if processor 600 determines that the detected values of these monitored parameters are less than or equal to the respective predetermined threshold values stored in 602, then processor 600 determines not to switch states.

If it is determined that channel states need to be switched (Y on S514), then control signals for the second channel state are generated (S516). For example, if processor 600 determines that the detected values of these monitored parameters are greater than the respective predetermined threshold values stored in 602, then processor 600 determines to switch states.

Referring to the example given with respect to FIG. 1, user 102 stops watching video on client device 106 and starts browsing the Web on client device 108. Referring now to FIG. 6B, client device 108 indicates that it requires high bandwidth service on channel 118. Network device 300 recognizes that client device 106 no longer needs full communications service on channel 116. Processor 600 generates control signals to configure radio system 302 into state 402.

Returning to FIG. 5, after control signals for the second channel state are generated (S516), control signals for the second channel state are transmitted (S518). Referring to FIG. 7B, processor 600 transmits control signals on control line 714 to configure MAC device 700, PHY device 702, RF module 704, and filter bank 706 into state 402.

Returning to FIG. 5, after control signals for the second channel state are transmitted (S518), data is transmitted and received on the second channel (S520). Referring to FIG. 7B, client device 108 transmits and receives data on channel 118.

Returning to FIG. 5, after data is transmitted and received on the second channel (S520), the first channel is monitored (S522). In this non-limiting example and referring to FIG. 7B, radio system 302 is configured to only receive data from client device 106 on channel 116. In another example, radio system 302 is configured to receive data from and also transmit low bandwidth, low priority data to client device 106 on channel 116.

Returning FIG. 5, after the first channel is monitored (S522), algorithm 500 ends (S524).

Today's home and work environments contain many Internet-enabled devices that are often networked using Wi-Fi. As Wi-Fi standards evolve, network devices and client devices adopt new protocols. Some newly-developed network devices can flexibly configure their radio systems to operate in 2.4, 5, or 6 GHz bands as needed. However, a network device cannot solely service one band; it must also monitor other bands for any client devices requesting service.

In accordance with the present disclosure, a network device is used with several client devices over two wireless communications channels. Each channel comprises a different radio frequency band. The network device can be placed in one state where it is transmitting and receiving data to client devices on a first channel while monitoring client devices on a second channel. In response to the monitored client devices, the network device can switch to another state where it is transmitting and receiving data to client devices on the second channel while monitoring client devices on the first channel.

The foregoing description of various preferred embodiments have been presented for purposes of illustration and description. It is not intended to be exhaustive or to limit the present disclosure to the precise forms disclosed, and obviously many modifications and variations are possible in light of the above teaching. The example embodiments, as described above, were chosen and described in order to best explain the principles of the present disclosure and its practical application to thereby enable others skilled in the art to best utilize the present disclosure in various embodiments and with various modifications as are suited to the particular use contemplated. It is intended that the scope of the present disclosure be defined by the claims appended hereto.

What is claimed is:

1. A network device for use with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel, said network device comprising:
a memory;
a radio system controllably configured to operate in a first channel state or a second channel state, the first channel state enabling transmission of the first client device reception data on the first channel, reception of the first client device transmission data on the first channel, and reception of the second client device transmission data on the second channel, the second channel state enabling transmission of the second client device reception data on the second channel, reception of the second client device transmission data on the second channel, and reception of the first client device transmission data on the first channel;
a control line arranged to provide a control signal to said radio system so as to place said radio system in either the first channel state or the second channel state; and
a processor configured to execute instructions stored on said memory to cause said network device to:
determine a portion of time for which said radio system should be configured to operate in the first channel state;
generate the control signal to place said radio system in the first channel state based on the determined portion of time;
transmit the control signal to said radio system via said control line to place said radio system in the first channel state upon generation of the control signal.

2. The network device of claim 1,
wherein said radio system comprises:
a medium access control (MAC) device configured to manage a link layer and frames associated with the first client device transmission data, the first client device reception data, the second client device transmission data, and the second client device reception data;
a physical layer (PHY) device configured to modulate the frames associated with the first client device transmission data and the second client device transmission data and to demodulate the frames associated with the first client device reception data and the second client device reception data;
a radio frequency (RF) module configured to associate the first client device transmission data to the first channel, disassociate the first client device reception data from the first channel, associate the second client device transmission data to the second channel, and disassociate the second client device reception data from the second channel;
a filter bank being controllably configured to operate in the first channel state or the second channel state;
a power amplifier configured to amplify the first client device transmission data and the second client device transmission data; and
a low noise amplifier operable to filter the first client device reception data and the second client device reception data, and
wherein said control line is arranged to provide the control signal to said filter bank so as to place said filter bank in either the first channel state or the second channel state.

3. The network device of claim 1, wherein said radio system is configured to operate in a first GHz band in the first state and to operate in a second GHz band in the second state.

4. The network device of claim 3, further comprising a second radio system configured to operate in a third GHz band while operating in the first state or the second state.

5. A method of using a network device with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel, said method comprising:
determining, via a processor configured to execute instructions stored on a memory, a portion of time for which a radio system should be configured to operate in a first channel state based on the monitored first client device parameter and the monitored second client device parameter, the radio system being controllably configured to operate in a first channel state or a second channel state, the first channel state enabling transmission of the first client device reception data on the first channel, reception of the first client device transmission data on the first channel, and reception of the second client device transmission data on the second channel, the second channel state enabling transmission of the second client device reception data on the second channel, reception of the second client device transmission data on the second channel, and reception of the first client device transmission data on the first channel;
generating, via the processor, the control signal to place the radio system in the first channel state based on the determined portion of time; and
transmitting, via the processor, the control signal to the radio system via a control line to place the radio system in the first channel state upon generation of the control signal.

6. The method of claim 5,
wherein the radio system comprises:
a medium access control (MAC) device configured to manage a link layer and frames associated with the first client device transmission data, the first client device reception data, the second client device transmission data, and the second client device reception data;
a physical layer (PHY) device configured to modulate the frames associated with the first client device transmission data and the second client device transmission data and to demodulate the frames associated with the first client device reception data and the second client device reception data;
a radio frequency (RF) module configured to associate the first client device transmission data to the first channel, disassociate the first client device reception data from the first channel, associate the second client device transmission data to the second channel, and disassociate the second client device reception data from the second channel;
a filter bank being controllably configured to operate in the first channel state or the second channel state;
a power amplifier configured to amplify the first client device transmission data and the second client device transmission data; and
a low noise amplifier operable to filter the first client device reception data and the second client device reception data; and
wherein said transmitting the control signal comprises transmitting the control signal to the filter bank so as to place the filter bank in either the first channel state or the second channel state.

7. The method of claim 5, wherein the radio system is configured to operate in a first GHz band in the first state and to operate in a second GHz band in the second state.

8. The method of claim 7, further comprising operating a second radio system in a third GHz band while operating in the first state or the second state.

9. A non-transitory, computer-readable media having computer-readable instructions stored thereon, the computer-readable instructions being capable of being read by a network device for use with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel, wherein the computer-readable instructions are capable of instructing the network device to perform the method comprising:
determining, via a processor configured to execute instructions stored on a memory, a portion of time for which a radio system should be configured to operate in a first channel state based on the monitored first client device parameter and the monitored second client device parameter, the radio system being controllably configured to operate in a first channel state or a second channel state, the first channel state enabling transmission of the first client device reception data on the first channel, reception of the first client device transmission data on the first channel, and reception of the second client device transmission data on the second channel, the second channel state enabling transmission of the second client device reception data on the second channel, reception of the second client device transmission data on the second channel, and reception of the first client device transmission data on the first channel;
generating, via the processor, the control signal to place the radio system in the first channel state based on the determined portion of time; and
transmitting, via the processor, the control signal to the radio system via a control line to place the radio system in the first channel state upon generation of the control signal.

10. The non-transitory, computer-readable media of claim 9, wherein the computer-readable instructions are capable of instructing the network device to perform the method
wherein the radio system comprises:
a medium access control (MAC) device configured to manage a link layer and frames associated with the first client device transmission data, the first client device reception data, the second client device transmission data, and the second client device reception data;
a physical layer (PHY) device configured to modulate the frames associated with the first client device transmission data and the second client device transmission data and to demodulate the frames associated with the first client device reception data and the second client device reception data;
a radio frequency (RF) module configured to associate the first client device transmission data to the first channel, disassociate the first client device reception data from the first channel, associate the second client device transmission data to the second channel, and disassociate the second client device reception data from the second channel;
a filter bank being controllably configured to operate in the first channel state or the second channel state;
a power amplifier configured to amplify the first client device transmission data and the second client device transmission data; and
a low noise amplifier operable to filter the first client device reception data and the second client device reception data; and
wherein said transmitting the control signal comprises transmitting the control signal to the filter bank so as to place the filter bank in either the first channel state or the second channel state.

11. The non-transitory, computer-readable media of claim 9, wherein the computer-readable instructions are capable of instructing the network device to perform the method wherein the radio system is configured to operate in a first GHz band in the first state and to operate in a second GHz band in the second state.

12. The non-transitory, computer-readable media of claim 11, wherein the computer-readable instructions are capable of instructing the network device to perform the method further comprising operating a second radio system in a third GHz band while operating in the first state or the second state.
